(19) United States
(12) Patent Application Publication
(10) Pub. No.: US 2001/0025900 A1
(43) Pub. Date: Oct. 4, 2001

(54) System and method for wind-powered flight

(76) Inventor: Dale C. Kramer, Port Colborne (CA)

Correspondence Address: Dale Kramer, 6 George Street, Port Colborne, ON, L3K 3S1, CA

(21) Appl. No.: 09/761,575

(22) Filed: Jan. 18, 2001

(30) Foreign Application Priority Data
Jan. 21, 2000 (CA) 2,296,935

(51) Int. Cl. B64C 31/02; B64C 31/06

(52) U.S. Cl. 244/2; 244/16; 244/153 R

(57) ABSTRACT

A system and method for wind-powered flight, comprising a low-speed, high-drag leading aircraft such as a kite, tethered to a low-speed, low-drag trailing aircraft, such as a glider. The leading aircraft is launched, and when the leading aircraft ascends into winds which are significantly greater than winds at the ground level and the takeoff velocity of the trailing aircraft, the leading aircraft begins to tow the trailing aircraft. The trailing aircraft becomes airborne and can be flown at a low air speed to maintain a constant drag on the leading aircraft, which in turn provides thrust to maintain the trailing aircraft aloft at the lower altitude.

### CROSS-REFERENCE TO RELATED APPLICATIONS

N/A

### FEDERALLY SPONSORED RESEARCH DEVELOPMENT

N/A

### BACKGROUND OF THE INVENTION

An aircraft requires lift in order to remain aloft. This vertical lift is produced by air flowing past an aerodynamic structure such as a wing. In the process of creating this lift a drag force perpendicular to the lift develops. If a thrust force is applied opposite and equal to the drag, the aircraft will remain aloft. If the thrust is greater than the drag, the aircraft could climb or accelerate to a speed at which the drag equals the thrust.

The typical mode of providing this thrust to aircraft such as airplanes, so-called “ultra-light” aircraft and helicopters, utilizes a motor-driven propeller or a jet engine. These types of aircraft are capable of self-ascent under the thrust provided by its propeller or jet engine, which generates sufficient thrust to overcome the drag force. However, each of these types of aircraft requires fuel to power the engine and is incapable of empowered flight.

Examples of aircraft which do not use any external power source are gliders, hang-gliders and para-gliders. However, these types of aircraft still require some external means of ascending to a height at which the aircraft can be flown. A glider, for example, is typically towed to the required altitude by a propeller-driven airplane, while hang-gliders and para-sails may be transported to the required altitude on land, for example up a mountain or to the edge of a precipice. Since there is no source of thrust, none of these aircraft is capable of self-ascent without the assistance of an external source of power, either human or mechanical, to elevate the aircraft to a flying altitude. To stay aloft these aircraft must rely on finding air that rises vertically at a greater speed than the aircraft is descending through the air.

Of conventional aircraft, only hot air balloons and dirigibles are capable of ascending without external assistance or the use of motor or jet engine. A hot air balloon relies on a furnace which heats air beneath an opening in the balloon to render it buoyant, while a dirigible is filled with an inherently buoyant gas such as helium. However, buoyant aircraft such as hot air balloons, which rely on wind currents to move horizontally, are difficult to control and notoriously subject to the vicissitudes of ambient weather and wind conditions, and as such dirigibles typically utilize a motor-driven propeller for thrust.

The present invention overcomes these disadvantages by providing a system and method for wind-powered flight, which requires no external power source or assistance. The system, involving a pair of wind-powered aircraft operating in tandem, is self-ascending and relies solely on wind differentials at various altitudes to both ascend and maintain a desired altitude. The system and method of the invention thus provides the advantage of virtually unlimited flight duration. As system of the invention does not consume or combust fuel, it is inexpensive to use and environmentally friendly.

The invention may be used to transport persons and/or cargo in the general direction of prevailing wind currents. The invention may also be enjoyed as a solo or team sport, involving considerable skill in the utilization of differential wind currents to maximize speed and distance.

The invention accomplishes this by providing a system and method for wind-powered flight, comprising a low-speed, high-drag leading aircraft, such as a kite, adapted to remain aloft under a force of lift provided by a high altitude wind acting against the aircraft in a flying direction. The leading aircraft is thus adapted for wind-powered ascent on a tether which provides the thrust force, to climb to a higher altitude. The invention further comprises a low-speed, low-drag trailing aircraft, such as a glider, tethered to the leading aircraft and adapted to remain aloft under a force of lift provided by the airfoils of the trailing aircraft moving through the air at a lower altitude.

The leading aircraft is launched, and when the leading aircraft ascends into winds which are significantly greater than winds at the ground level and the takeoff velocity of the trailing aircraft, the leading aircraft begins to tow the trailing aircraft. Because the wind speed at the higher altitude of the leading aircraft is significantly greater than the ground winds and the takeoff velocity of the trailing aircraft, the trailing aircraft becomes airborne. As the trailing aircraft ascends, the leading aircraft ascends with it, constantly maintaining an altitude difference to take advantage of the higher wind speeds at higher altitudes. The trailing aircraft is flown at a low airspeed, such that its ground speed is less than the ground speed of the higher altitude wind, to maintain a constant drag on the leading aircraft. The leading aircraft in turn provides thrust to the trailing aircraft, to provide the lift necessary for the trailing aircraft to remain aloft. In effect, the leading aircraft extracts wind energy from the higher altitude wind to tow the trailing aircraft at a sufficient wind speed as to maintain the trailing aircraft aloft at the lower altitude.

The present invention thus provides a system for wind-powered flight, comprising a tethered low-speed, high-drag leading aircraft, adapted to remain aloft under a force of lift provided by a high altitude wind acting against the leading aircraft in a flying direction, a force of drag against the leading aircraft being opposed by a tether attached to the leading aircraft, for wind-powered ascent to a first altitude, and a low-speed, low-drag trailing aircraft tethered to the leading aircraft, and adapted to remain aloft under a force of lift provided by one or more airfoils moving through air at a second altitude which is lower than the first altitude, wherein the leading aircraft extracts wind energy from the high altitude wind to tow the trailing aircraft at a sufficient air speed to maintain the trailing aircraft aloft.

The present invention further provides a method of wind-powered flight utilizing a tethered low-speed, high-drag leading aircraft adapted to remain aloft under a force of lift provided by a high altitude wind acting against the aircraft in a flying direction, a force of drag against the leading aircraft being opposed by a tether attached to the leading aircraft, and a low-speed, low-drag trailing aircraft tethered to the leading aircraft and adapted to remain aloft under a force of lift provided by one or more airfoils moving through air in the flying direction, comprising the steps of: a. tethering the leading aircraft to the trailing aircraft, b. stabilizing the leading aircraft so that it ascends to a higher altitude, and c. towing the trailing aircraft in a flying direction, such that the trailing aircraft ascends to a lower altitude, wherein a difference between a speed of a high altitude wind in the flying direction at the higher altitude and a speed in the flying direction of a wind at the lower altitude equals or exceeds a takeoff velocity of the trailing aircraft plus a speed of wind across the leading aircraft sufficient to generate a force of lift on the leading aircraft which allows the leading aircraft to remain aloft.

### BRIEF DESCRIPTION OF THE DRAWINGS

In drawings which illustrate by way of example only a preferred embodiment of the invention,

FIG. 1 is a schematic side view of the system of the invention.

### DETAILED DESCRIPTION OF THE INVENTION

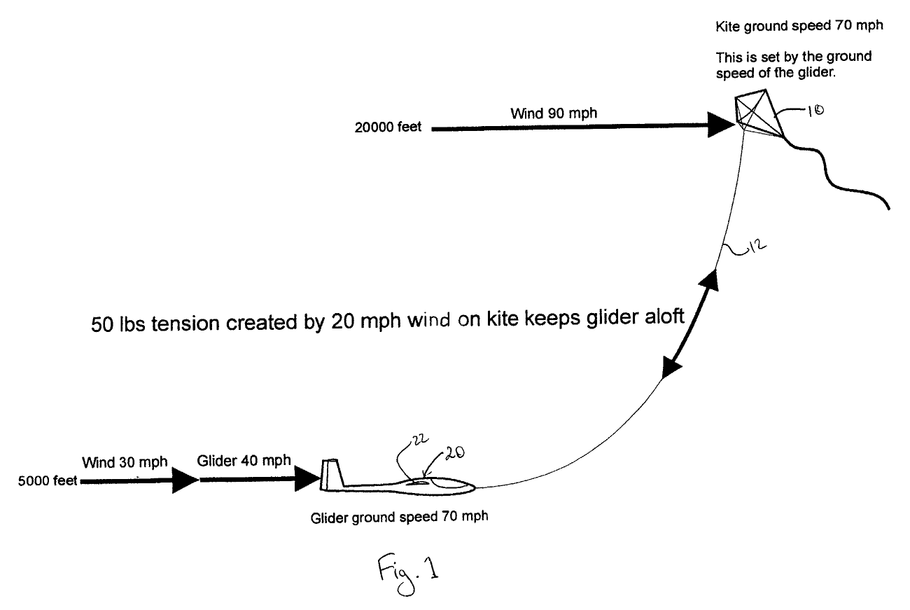

FIG. 1 illustrates a system for wind-powered flight according to the invention. A tethered low-speed, high-drag leading aircraft, such as a kite 10, is adapted to remain aloft under a force of lift provided by a wind acting against the aircraft in a flying direction. The leading aircraft 10 preferably has a relatively low lift-to-drag ratio, for example in the range of 1:1 to 10:1. In the preferred embodiment illustrated, the lift-to-drag ratio of the kite 10 is in the order of 1:1. The leading aircraft 10 may be a kite, a para-glider, or any like low-speed, high-drag tethered aircraft, and may optionally carry a pilot.

The leading aircraft 10 is stabilized by a tether 12, which maintains the leading aircraft 10 at an orientation, relative to the direction of the wind, and provides the thrust necessary to keep the leading aircraft 10 aloft. The tether 12 is in turn attached to a low-speed, low-drag trailing aircraft, such as a glider 20, which in the preferred embodiment shown has a lift-to-drag ratio in the order of 30:1. The glider 20, controlled by a pilot, has wings 22 with airfoils, and thus remains aloft as it moves through air in the flying direction. This generates lift sufficient to overcome the force of gravity, as is well known to those skilled in the art.

In order to maintain a constant altitude the glider 20 requires sufficient thrust to generate lift equal to its weight. This thrust is provided by the leading aircraft 10. The invention relies on the difference between the wind speeds at a higher altitudes and the wind speeds at a lower altitudes. A significant wind speed differential is typical in regions with prevailing air currents such as the jet stream, where on most days the wind speed at a higher altitude is significantly greater than the wind speed at a lower altitude.

According to the system, the leading aircraft 10, which in the example shown is a kite, is launched downwind in a conventional fashion. The tether 12 is unwound from a reel or other suitable payoff device (not shown), to allow the kite 10 to ascend to an altitude at which the wind speed in the flying direction exceeds the wind speed at ground level plus the takeoff velocity of the trailing aircraft 20 plus the wind speed across the leading aircraft 10, in the example shown a glider which has a takeoff velocity of approximately 30 m.p.h.

When the kite 10 has ascended into winds which are significantly greater than the wind speed at ground level plus the takeoff velocity of the glider 20 plus the wind speed across the kite 10, the glider brake is released and the kite 10 begins to tow the glider 20 in the flying direction. The glider 20 becomes airborne and the kite 10 and glider 20 ascend, in tandem, to the desired altitude. According to the example illustrated in FIG. 1, the glider 20 ascends to 5,000 feet where the wind speed in the flying direction is 30 m.p.h., while the kite 10 ascends to 20,000 feet, where the wind speed in the flying direction is 90 m.p.h. The length of the tether 12 must accommodate the vertical distance between the leading aircraft 10 and the trailing aircraft 20, the horizontal distance between the leading aircraft 10 and the trailing aircraft 20, and the ‘droop’ caused by the weight of the tether 12 over such a large distance. The tether 12 can be shortened or lengthened by the pilot in the glider 20 as needed during the flight, to accommodate disparate wind differentials at different altitudes.

Once the trailing aircraft 20 has reached the selected cruising altitude (5,000 feet in the embodiment shown), the thrust provided by the drag on the leading aircraft 10 maintains the trailing aircraft 20 aloft. The glider 20 must maintain a wind speed of approximately 40 m.p.h. in the flying direction, which requires approximately 50 lbs. of thrust, i.e. 50 lbs. of tension on the tether 12.

With a 30 m.p.h. tail wind at the lower altitude, the trailing aircraft 20 must maintain a ground speed of approximately 70 m.p.h. (with a flying speed of 40 m.p.h.) in order to maintain a constant altitude. This sets the ground speed of the kite 10 to 70 m.p.h. in the 90 m.p.h. wind at the higher altitude. Thus, the kite 10 experiences a constant wind of 20 m.p.h., the difference between its ground speed and the ground speed of the higher altitude wind, which maintains tension in the tether 12 and thus provides thrust to the glider 20.

In effect, the leading aircraft 10 extracts wind energy from the higher altitude wind to tow the trailing aircraft at a sufficient air speed to maintain the trailing aircraft aloft.

Preferably the glider 20 is flown at speed which results in the minimum drag on the glider 20, i.e. maximizing the lift-to-drag ratio. The glider pilot controls the air speed of the kite 10 by controlling the air speed of the glider 20 and, if necessary, adjusting the length of the tether 12 to alter the altitude differential between the kite 10 and the glider 20 to accommodate wind speed changes. It will be appreciated that with a sufficient wind speed differential there is virtually no limit to the length or duration of flight according to the system of the invention, while the system of the invention affords a skilled pilot considerably more control than a balloonist.

It will also be appreciated that the flying direction does not have to be the same as the wind direction, so long as the components of the higher and lower altitude winds in the flying direction provide the necessary wind speed differential to meet the minimum air speed of the trailing aircraft 20.

To land the system of the invention, the pilot reels in the tether 12 to reduce the altitude differential between the leading aircraft 10 and the trailing aircraft 20. This commensurately reduces the wind speed differential, and thus the thrust exerted on the trailing aircraft 20. As the trailing aircraft 20 descends its speed increases, while the higher altitude wind speed acting on the leading aircraft 10 decreases, to the point where the leading aircraft 10 has a positive air speed and experiences drag in the direction opposite to the flying direction. As the trailing aircraft 20 lands the leading aircraft 10 is maintained at a low altitude (e.g. 100 feet) by the forward speed of the trailing aircraft 20, and actually assists in braking the trailing aircraft 20.

It is possible to supplement the lift on the leading aircraft by using a buoyant gas such as helium, however this would ordinarily be unnecessary in the preferred embodiment because of the low speed, high drag and low speed, low drag characteristics of the leading aircraft 10 and trailing aircraft 20, respectively.

Also, although the invention has been described in relation to a flight path which generally follows the direction of the wind, it may be possible to design a system according to the invention which can fly across the wind, and possibly even into the wind at a small angle.

As a sport, the system of the invention could be flown solo by the glider pilot, or as a team by providing a pilot for the leading aircraft. In the latter situation either the leading aircraft 10 or the trailing aircraft 20 can control the flight path (although the ground speed remains controlled by the trailing aircraft 20), so that one pilot can sleep while the other pilots the system. Launching of the trailing aircraft 20 can be facilitated by a motor- or human-powered device such as a bicycle forming part of the frame for carrying the pilot of the trailing aircraft 20.

A preferred embodiment of the invention having been thus described by way of example only, it will be apparent to those skilled in the art that certain modifications and adaptations will be apparent to those skilled in the art. The invention is intended to include all such modifications and adaptations as fall within the scope of the appended claims.

I claim:

1. A system for wind-powered flight, comprising
a tethered low-speed, high-drag leading aircraft, adapted to remain aloft under a force of lift provided by a high altitude wind acting against the aircraft in a flying direction, a force of drag against the leading aircraft being opposed by a tether attached to the leading aircraft, for wind-powered ascent to a first altitude, and
a low-speed, low-drag trailing aircraft tethered to the leading aircraft, and adapted to remain aloft under a force of lift provided by one or more airfoils moving through air at a second altitude which is lower than the first altitude,
wherein the leading aircraft extracts wind energy from the high altitude wind to tow the trailing aircraft at a sufficient air speed to maintain the trailing aircraft aloft.

2. The system of claim 1 in which the leading aircraft is a kite.

3. The system of claim 1 in which the trailing aircraft is a glider.

4. The system of claim 1 in which the leading aircraft is adapted to transport one or more passengers or cargo.

5. The system of claim 1 in which the trailing aircraft is adapted to transport one or more passengers or cargo.

6. A method of wind-powered flight utilizing a tethered low-speed, high-drag leading aircraft adapted to remain aloft under a force of lift provided by a high altitude wind acting against the aircraft in a flying direction, a force of drag against the leading aircraft being opposed by a tether attached to the leading aircraft, and a low-speed, low-drag trailing aircraft tethered to the leading aircraft and adapted to remain aloft under a force of lift provided by one or more airfoils moving through air in the flying direction, comprising the steps of
a. tethering the leading aircraft to the trailing aircraft,
b. stabilizing the leading aircraft so that it ascends to a higher altitude, and
c. towing the trailing aircraft in a flying direction, such that the trailing aircraft ascends to a lower altitude,
wherein a difference between a speed of a high altitude wind in the flying direction at the higher altitude and a speed in the flying direction of a wind at the lower altitude equals or exceeds a takeoff velocity of the trailing aircraft plus a speed of wind across the leading aircraft sufficient to generate a force of lift on the leading aircraft which allows the leading aircraft to remain aloft.
